(19) United States
(12) Patent Application Publication
(10) Pub. No.: US 2025/0228210 A1
(43) Pub. Date: Jul. 17, 2025

(54) Cattle Prod

(71) Applicant: James Mardis, Canyon, TX (US)

(72) Inventor: James Mardis, Canyon, TX (US)

(21) Appl. No.: 18/988,204

(22) Filed: Dec. 19, 2024

Related U.S. Application Data
(60) Provisional application No. 63/621,770, filed on Jan. 17, 2024.

(51) Int. Cl. A01K 15/02

(52) U.S. Cl. CPC A01K 15/029; A01K 15/028

(57) ABSTRACT

A cattle prod comprising an electrical prod for the livestock industry, the cattle prod is disclosed. Comprising the cattle prod comprises handle assembly and shaft assembly. The handle assembly comprises a handle portion having a first handle end and a second handle end, a first coupling assembly at the first handle end, an activation button, and a battery for operating the cattle prod. The shaft assembly comprises a shaft portion having a first shaft end and a second shaft end, a second coupling assembly at the first shaft end, a prod assembly at the second shaft end. The second coupling assembly and the first coupling assembly are configured to selectively attach to one another. The handle assembly comprises a core housing body having a button aperture, an upper coupling interface, and an internal cavity.

### CROSS-REFERENCE TO RELATED APPLICATIONS

This application claims benefit to U.S. provisional utility application No. 63/621,770 filed 2024 Jan. 17.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

The present invention relates generally to livestock management tools and more specifically to an improved electric livestock prod for handling and directing livestock. Livestock prods have been an essential tool in animal husbandry for many years, aiding in the movement and control of livestock in various agricultural settings.

Traditional electric livestock prods have several common limitations. These include concerns regarding durability, especially under adverse weather conditions, limited battery life, and ergonomic deficiencies that can lead to user fatigue or discomfort during extended use. Additionally, the need for frequent charging and the risk of water damage due to inadequate waterproofing have been persistent challenges. The clamshell design used in prior art often leads to water leakage, increasing the risk of electrical shock to the user.

The primary competitor in this market offers electric livestock prods that, while popular, have not addressed these limitations satisfactorily. There is a recognized need for a livestock prod that is more durable, ergonomically designed, and better suited for use in various environmental conditions.

The current disclosure seeks to address these issues with several innovative features. It introduces a one-piece rubber over-molded handle for enhanced ergonomics and balance, making it more comfortable for prolonged use. The waterproof design, achieved using high-quality materials for buttons and other components, ensures reliability and safety in different weather conditions. Unlike the clamshell design, the handle can be injection-molded as a cylindrical cup, closed at one end, and then over-molded with a rubber or rubber-like material to create a secure moisture barrier, preventing shocks to the user.

Furthermore, the current disclosure distinguishes itself with additional features. These include the incorporation of magnets for convenient attachment to fences, facilitating ease of access and storage in ranch settings. The introduction of wireless charging capabilities, similar to Qi charging technology, not only enhances the waterproof nature of the device but also simplifies the charging process, thereby addressing a key user concern.

The advancements presented in the current disclosure represent significant steps forward in the field of electric livestock prods, offering enhanced usability, durability, and functionality, all of which are vital for effective and humane livestock management. This includes the device's use in stocker operations, cow-calf operations, feed yards, and swine operations, where resilience and user safety are crucial considerations.

No prior art is known to the Applicant.

### BRIEF SUMMARY OF THE INVENTION

A cattle prod comprising an electrical prod for the livestock industry, said cattle prod is disclosed. Comprising said cattle prod comprises handle assembly and shaft assembly. Said handle assembly comprises a handle portion having a first handle end and a second handle end, a first coupling assembly at said first handle end, an activation button, and a battery for operating said cattle prod. Said shaft assembly comprises a shaft portion having a first shaft end and a second shaft end, a second coupling assembly at said first shaft end, a prod assembly at said second shaft end. Said second coupling assembly and said first coupling assembly are configured to selectively attach to one another. Said handle assembly comprises a core housing body having a button aperture, an upper coupling interface, and an internal cavity. Said handle assembly is configured to enclose said internal cavity of said handle assembly. Said internal cavity is configured to hold one or more electrical components of said cattle prod. Said internal cavity is further configured to be sealed from environmental contamination and moisture. Said upper coupling interface is configured for matting with said shaft assembly. Said button aperture is configured for mating with said activation button, said cattle prod is configured to couple said internal cavity with said shaft assembly using said first coupling assembly and said second coupling assembly, said handle assembly comprises said core housing body and a protective coating. Said handle assembly protects said internal cavity by sealing said activation button under a portion of said protective coating securely channeling said internal cavity into a portion of said shaft assembly through said first coupling assembly and said second coupling assembly. Said activation button is configured to be useful through a portion of said protective coating which is flexible allowing movement of said activation button. Said handle assembly comprises said core housing body comprising an injection molded polymer, and said protective coating comprising a secondary over molding to encapsulate said core housing body. Said protective coating comprises a grip portion of said handle assembly. Said protective coating extends to the edges of said button aperture, further safeguarding said activation button from environmental exposure.

Said cattle prod comprising an electrical prod for the livestock industry, said cattle prod is disclosed. Comprising said cattle prod comprises handle assembly and shaft assembly. Said handle assembly comprises the handle portion having the first handle end and the second handle end, the first coupling assembly at said first handle end, the activation button, and the battery for operating said cattle prod. Said shaft assembly comprises the shaft portion having the first shaft end and the second shaft end, the second coupling assembly at said first shaft end, the prod assembly at said second shaft end. Said second coupling assembly and said first coupling assembly are configured to selectively attach to one another. Said handle assembly comprises the core housing body having the button aperture, the upper coupling interface, and the internal cavity. Said handle assembly is configured to enclose said internal cavity of said handle assembly. Said internal cavity is configured to hold one or more electrical components of said cattle prod. Said internal cavity is further configured to be sealed from environmental contamination and moisture. Said upper coupling interface is configured for matting with said shaft assembly. Said button aperture is configured for mating with said activation button, said cattle prod is configured to couple said internal cavity with said shaft assembly using said first coupling assembly and said second coupling assembly, said handle assembly comprises said core housing body and the protective coating. Said handle assembly protects said internal cavity by sealing said activation button under a portion of said protective coating securely channeling said internal cavity into a portion of said shaft assembly through said first coupling assembly and said second coupling assembly. Said activation button is configured to be useful through a portion of said protective coating which is flexible allowing movement of said activation button.

Said cattle prod comprising an electrical prod for the livestock industry, said cattle prod is disclosed. Comprising said cattle prod comprises handle assembly and shaft assembly. Said handle assembly comprises the handle portion having the first handle end and the second handle end, the first coupling assembly at said first handle end, the activation button, and the battery for operating said cattle prod. Said shaft assembly comprises the shaft portion having the first shaft end and the second shaft end, the second coupling assembly at said first shaft end, the prod assembly at said second shaft end. Said second coupling assembly and said first coupling assembly are configured to selectively attach to one another. Said handle assembly comprises the core housing body having the button aperture, the upper coupling interface, and the internal cavity. Said handle assembly is configured to enclose said internal cavity of said handle assembly. Said internal cavity is configured to hold one or more electrical components of said cattle prod. Said internal cavity is further configured to be sealed from environmental contamination and moisture. Said upper coupling interface is configured for matting with said shaft assembly. Said button aperture is configured for mating with said activation button, said cattle prod is configured to couple said internal cavity with said shaft assembly using said first coupling assembly and said second coupling assembly, said handle assembly comprises said core housing body and the protective coating. Said handle assembly protects said internal cavity by sealing said activation button under a portion of said protective coating securely channeling said internal cavity into a portion of said shaft assembly through said first coupling assembly and said second coupling assembly. Said activation button is configured to be useful through a portion of said protective coating which is flexible allowing movement of said activation button. Said cattle prod further comprises a wireless charging receiver and a wireless charging base. Said wireless charging receiver is encased within said cattle prod. Said wireless charging receiver and said wireless charging base selectively mate to wirelessly charge said battery.

### BRIEF DESCRIPTION OF THE SEVERAL VIEWS OF THE DRAWING

FIG. 1 illustrates a perspective overview of a cattle prod 100.

FIGS. 2A and 2B illustrate a perspective two views of a second handle end 114 of a handle assembly 102.

FIG. 3 illustrates a detailed perspective overview of a first handle end 112 and a first coupling assembly 108 of said handle assembly 102.

FIG. 4 illustrates a block diagram of said cattle prod 100.

FIG. 5 illustrates a block diagram of said cattle prod 100 with the addition of a wireless charging receiver 500 and a wireless charging base 502.

FIG. 6 illustrates a perspective overview of handle assembly 102.

FIG. 7 illustrates a perspective overview of said cattle prod 100 with or more magnets 600 externally positioned relative to a handle portion 106.

FIGS. 8A and 8B illustrate a cross-section elevated front view of cattle prod 100 in an exploded view and an assembled view, respectively.

FIG. 9 illustrates a cross-section elevated front view of cattle prod 100 with the addition of one or more magnets 600.

FIG. 10 illustrates a perspective overview of said handle assembly 102 featuring a magnet sleeve assembly 1000.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

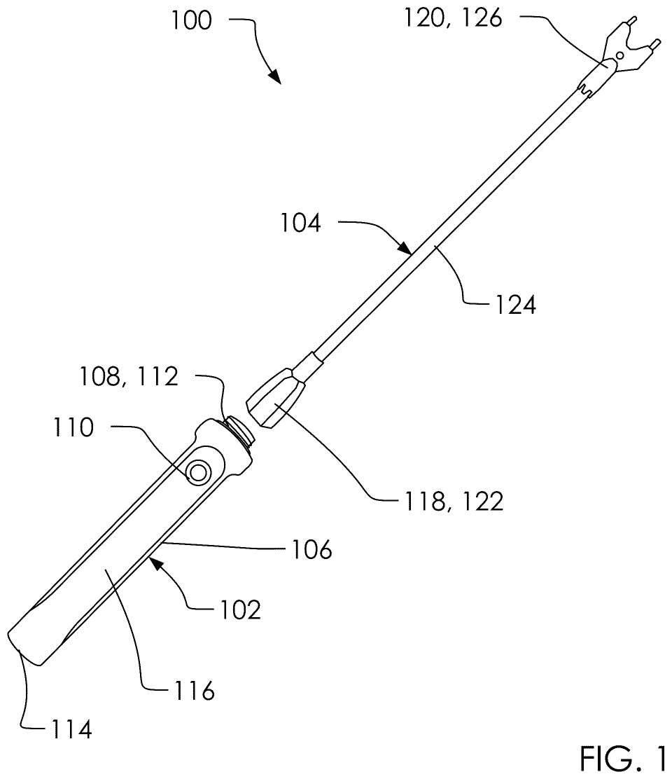

FIG. 1 illustrates a perspective overview of a cattle prod 100.

In one embodiment, said cattle prod 100 can comprise a handle assembly 102 and a shaft assembly 104.

Said handle assembly 102 can comprise a handle portion 106, a first coupling assembly 108, an activation button 110, a first handle end 112, a second handle end 114, and a grip portion 116. Wherein, said grip portion 116 can wrap around a portion of said handle portion 106 and provide a gripping surface for a user. In one embodiment, said first coupling assembly 108 can be at said second handle end 114 and configured to selectively attach to said shaft assembly 104. Further, said first coupling assembly 108 can comprise a male-threaded portion for attaching to said shaft assembly 104.

Said activation button 110 can be configured to activate a current in said cattle prod 100 for use in sending an electrical shock through a portion of said shaft assembly 104.

In one embodiment, said shaft assembly 104 can comprise a first shaft end 118 and a second shaft end 120, a second coupling assembly 122, a shaft portion 124, and a prod assembly 126. Wherein, said second coupling assembly 122 can be at said first shaft end 118 of said shaft assembly 104, said prod assembly 126 can be at said second shaft end 120 of said shaft assembly 104. In one embodiment, said shaft portion 124 can extend between said first shaft end 118 and said second shaft end 120.

In one embodiment, an enhancement in the durability of said cattle prod 100 can comprise the introduction of an injection-molded shaft, specifically in said shaft assembly 104. This improvement increases the robustness and longevity of said shaft assembly 104, making it more resistant to wear and damage. Such an enhancement is particularly beneficial under the rigorous conditions of livestock management.

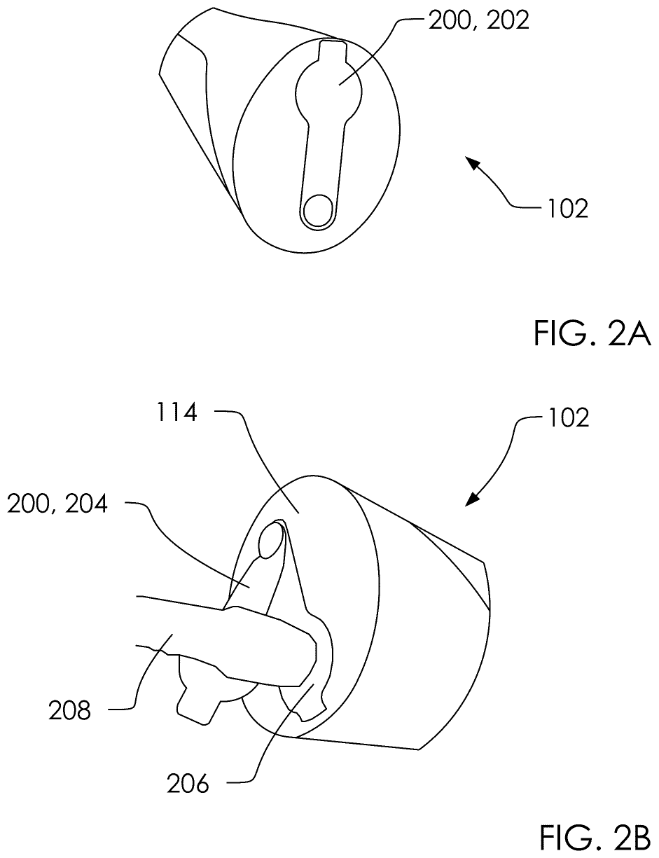

FIGS. 2A and 2B illustrate a perspective two views of said second handle end 114 of said handle assembly 102.

In one embodiment, said second handle end 114 of said handle assembly 102 can comprise a charging port cover 200, configured to selectively open and close in a closed configuration 202 and an open configuration 204. Said charging port cover 200 can be configured to selectively cover a charging port 206 used to charge said cattle prod 100 using a charging cable 208.

In one embodiment, said charging port cover 200 can be a portion of said grip portion 116 and, further, can serve to keep said cattle prod 100—especially said charging port 206—watertight during use in the field.

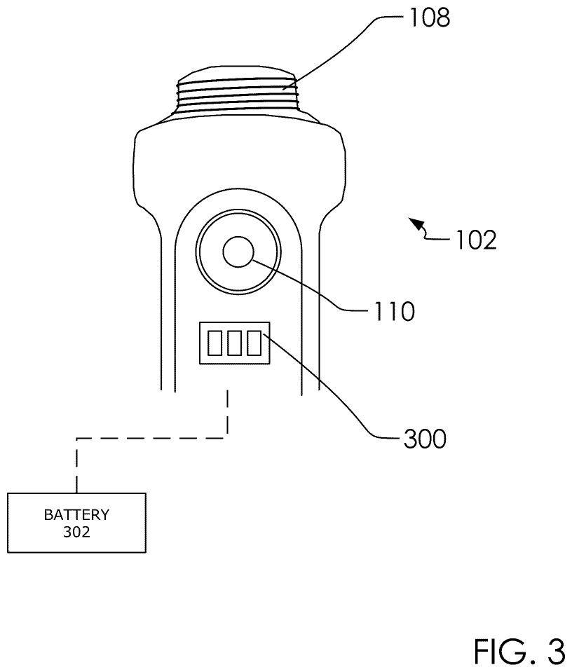

FIG. 3 illustrates a detailed perspective overview of said first handle end 112 and said first coupling assembly 108 of said handle assembly 102.

Said cattle prod 100 can further comprise a power meter 300 and a battery 302. In one embodiment, said activation button 110 can regulate power delivered from said battery 302 to said prod assembly 126. Likewise, said power meter 300 can monitor a power level of said battery 302.

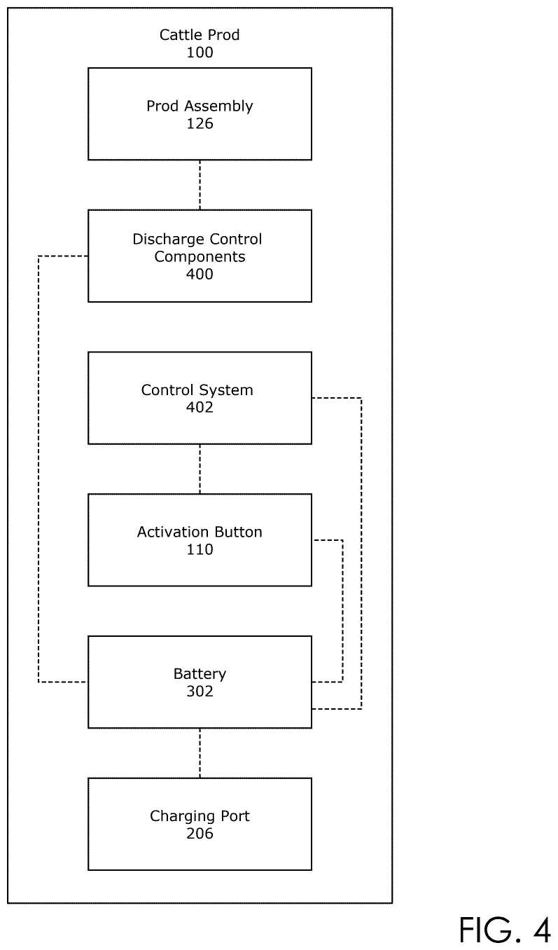

FIG. 4 illustrates a block diagram of said cattle prod 100.

In one embodiment, said cattle prod 100 can comprise one or more discharge control components 400 and a control system 402.

In one embodiment, cattle prod 100 can control the charge and discharge of prod assembly 126 using control system 402. In one embodiment, one or more discharge control components 400 can build up an electrical charge or use by prod assembly 126.

Said control system 402 can comprise a computer having memory, software, and processors configured to manage the operation of said prod assembly 126.

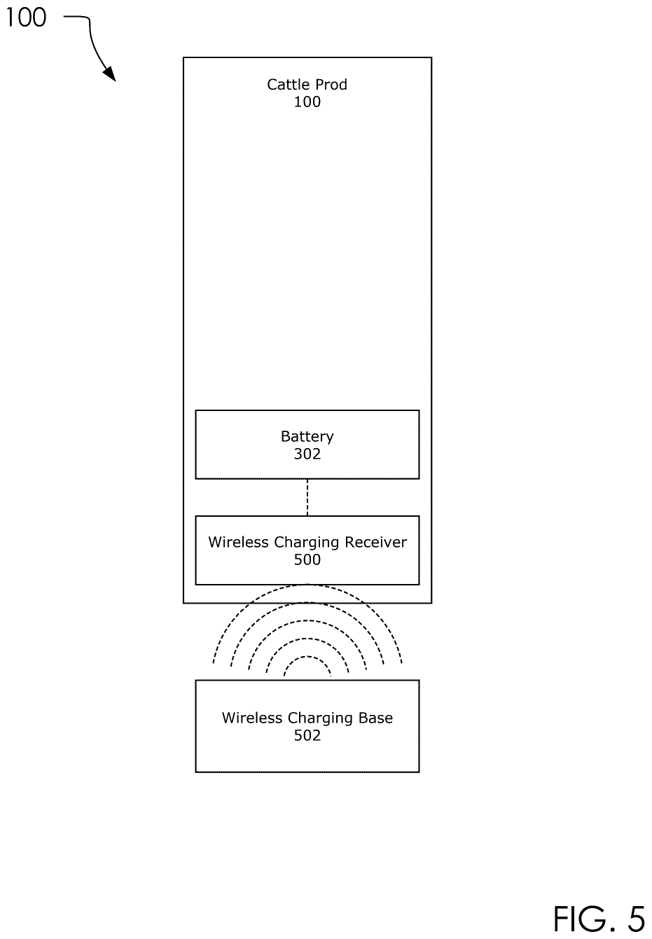

FIG. 5 illustrates a block diagram of said cattle prod 100 with the addition of a wireless charging receiver 500 and a wireless charging base 502.

In one embodiment, cattle prod 100 can further comprise wireless charging receiver 500 and wireless charging base 502.

In one embodiment, cattle prod 100 can comprise a wireless charging feature utilizing said wireless charging receiver 500 and said wireless charging base 502. This feature not only reinforces the waterproof nature of said cattle prod 100 but also simplifies the charging process. The ease of wireless charging addresses a key concern among users regarding the maintenance and readiness of their livestock management tools.

In one embodiment, said wireless charging receiver 500 and said wireless charging base 502 can operate using inductive charging technology. This technology facilitates energy transfer without physical connections, enhancing the waterproof integrity of said cattle prod 100.

Said wireless charging receiver 500 can be strategically positioned within said cattle prod 100 to optimize alignment with said wireless charging base 502. This placement ensures efficient energy transfer when said cattle prod 100 is docked on said wireless charging base 502.

The design eliminates wear and tear associated with traditional charging ports, thereby increasing the longevity of said cattle prod 100. Furthermore, this feature simplifies the charging process, providing users with a reliable and convenient solution for maintaining operational readiness.

In one embodiment, said wireless charging system is equipped with safeguards to ensure safe operation in adverse environmental conditions, such as wet or dusty settings. These safeguards include waterproof seals and materials that protect the internal components of said cattle prod 100 during charging. Such considerations make said wireless charging receiver 500 and said wireless charging base 502 particularly suited for rugged agricultural environments.

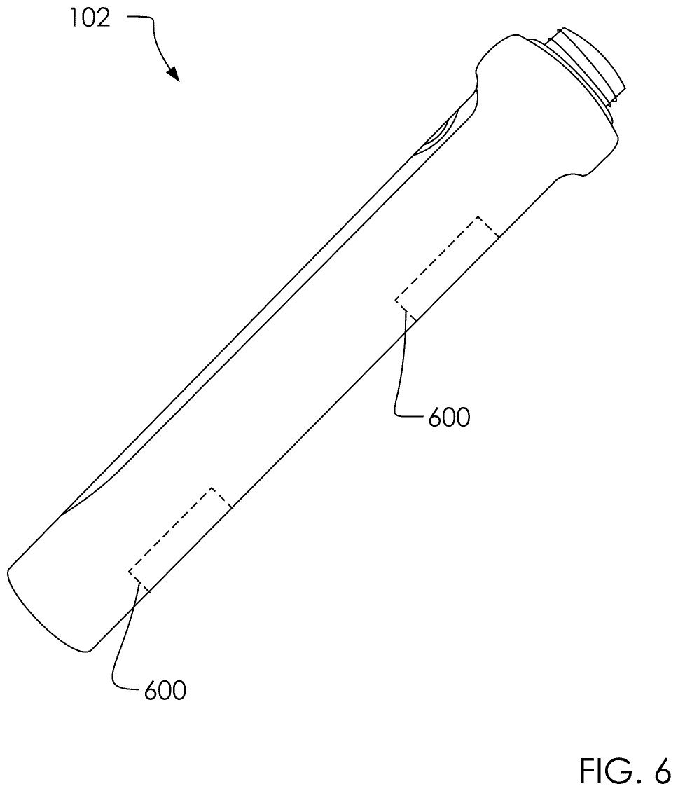

FIG. 6 illustrates a perspective overview of handle assembly 102.

In one embodiment, said handle assembly 102 can further comprise one or more magnets 600, specifically designed to allow attachment to metal surfaces, such as fences commonly found in ranch environments. Said one or more magnets 600 can be inside of handle assembly 102, as illustrated.

One advantage of said cattle prod 100 is its enhanced waterproof design, which improves reliable operation in various weather conditions. This can be achieved using high-quality rubber materials, particularly in the construction of said activation button 110 and said grip portion 116. Such design considerations ensure that said cattle prod 100 remains operational and safe, even in wet or humid environments.

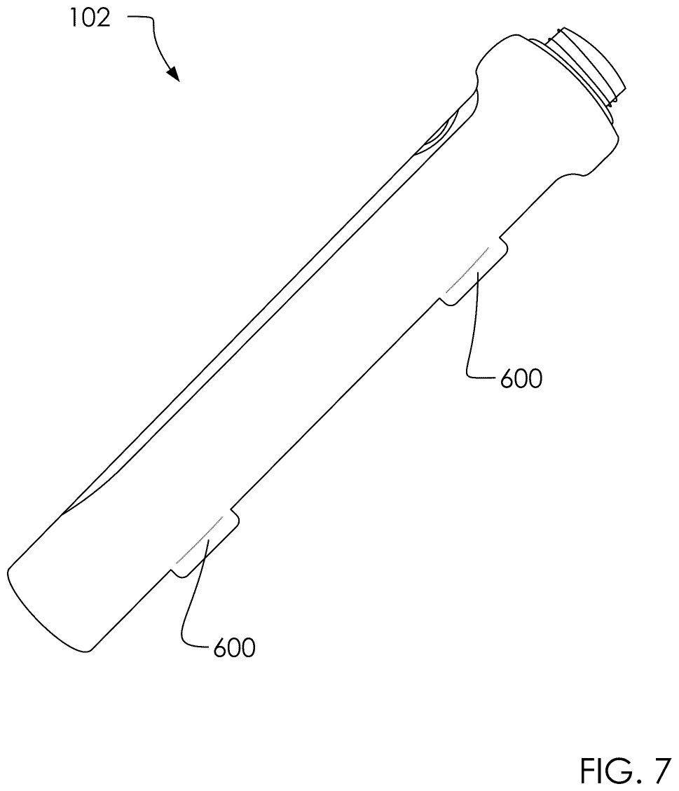

FIG. 7 illustrates a perspective overview of said cattle prod 100 with said one or more magnets 600 externally positioned relative to said handle portion 106.

In one embodiment, said one or more magnets 600 can be molded into to an exterior portion of said handle assembly 102, as illustrated. This external placement allows for convenient attachment of said cattle prod 100 to metallic surfaces, such as fences or storage racks commonly found in ranch environments.

The external configuration of said one or more magnets 600 can provide enhanced usability by enabling the user to secure said cattle prod 100 without interfering with its internal components. This design ensures that the structural and functional integrity of said handle assembly 102 remains uncompromised.

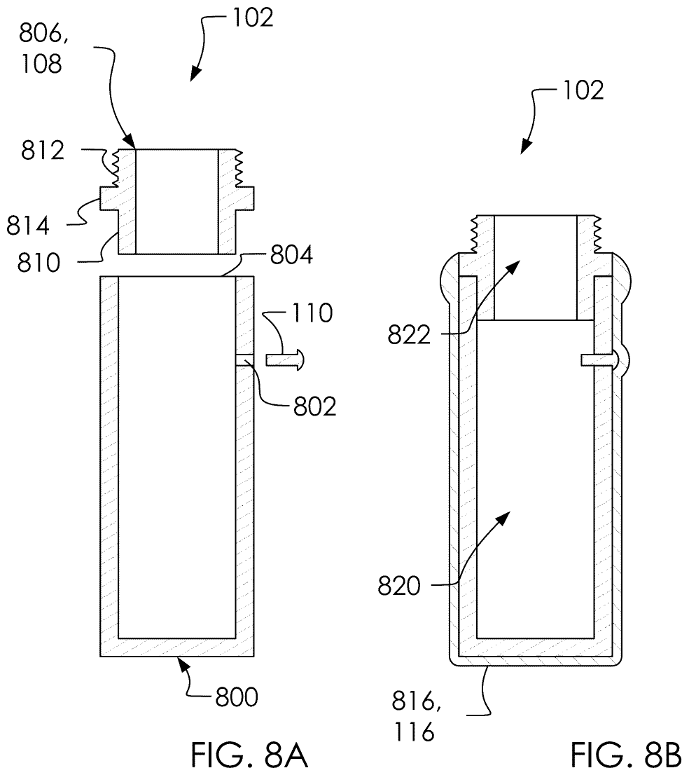

FIGS. 8A and 8B illustrate a cross-section elevated front view of cattle prod 100 in an exploded view and an assembled view, respectively.

In one embodiment, said cattle prod 100 can comprise a core housing body 800 having a button aperture 802 and an upper coupling interface 804. Said cattle prod 100 can further include a threaded connector assembly 806, comprising a base connector 810, an threaded attachment collar 812, and a sealing flange 814.

Said core housing body 800 with said button aperture 802 designed to accommodate said activation button 110 and said upper coupling interface 804.

Said base connector 810 slides into said upper coupling interface 804 of said core housing body 800, while said sealing flange 814 rests on the upper edge of said core housing body 800 around said upper coupling interface 804. Said threaded connector assembly 806 is securely attached to said core housing body 800 using a heat or chemical bonding process. Both said core housing body 800 and said threaded connector assembly 806 comprise internal cavities designed to house internal components, including said one or more discharge control components 400, said control system 402, said battery 302, and said wireless charging receiver 500. Said activation button 110 is accessible externally on said core housing body 800 and operates by pressing a switch within said core housing body 800 to control said cattle prod 100.

A threaded coupling assembly 808 can secure said handle assembly 102 to said shaft assembly 104, providing a robust and reliable connection.

In one embodiment, handle assembly 102 can further comprise a protective coating 816, which can comprise said grip portion 116.

Said protective coating 816 can encapsulate said core housing body 800, providing a weather-resistant barrier that enhances the durability and reliability of said handle assembly 102. This coating can prevent ingress of moisture or debris, ensuring the continued functionality of internal components such as said one or more discharge control components 400, said control system 402, said battery 302, and said wireless charging receiver 500.

In one embodiment, the molding processes utilized in said handle assembly 102 can involve a two-stage injection molding technique. Initially, said core housing body 800 is formed using a high-strength polymer material, providing a rigid and durable framework for housing internal components. Once the base structure is completed, a secondary over molding process applies said protective coating 816 to encapsulate said core housing body 800.

This over molding step employs a weather-resistant material, designed to provide a moisture barrier and enhanced grip for the user. During the over molding process, the material adheres seamlessly to the surface of said core housing body 800, ensuring a watertight seal and preventing delamination over time. This protective coating also extends to the edges of said button aperture 802, further safeguarding said activation button 110 from environmental exposure.

In one embodiment, said weather-resistant material can comprise rubber.

The integration of these processes results in a robust, weather-resistant handle assembly that ensures the continued functionality and reliability of internal components such as said one or more discharge control components 400, said control system 402, and said battery 302, even under rigorous agricultural conditions.

In one embodiment, said handle assembly 102 is configured to enclose an internal cavity 820 of handle assembly 102. Said internal cavity 820 is configured to protect one or more electrical components of cattle prod 100 from environmental contamination and moisture. Sealing internal cavity 820 within handle assembly 102 can comprise constructing core housing body 800 as an enclosed manifold having upper coupling interface 804 for matting with shaft assembly 104 and button aperture 802 for mating with activation button 110, coupling internal cavity 820 with shaft assembly 104 using said first coupling assembly 108 and said second coupling assembly 122, and sealing activation button 110 under a portion of protective coating 816 while allowing activation button 110 to function to activate cattle prod 100.

Said threaded connector assembly 806 can comprise a connector channel 822 which creates a channel between internal cavity 820 and shaft assembly 104.

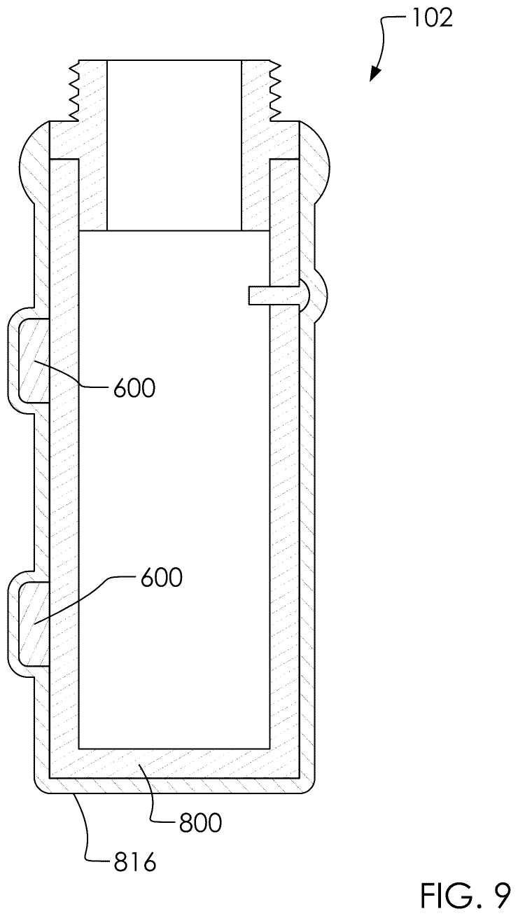

FIG. 9 illustrates a cross-section elevated front view of cattle prod 100 with the addition of one or more magnets 600.

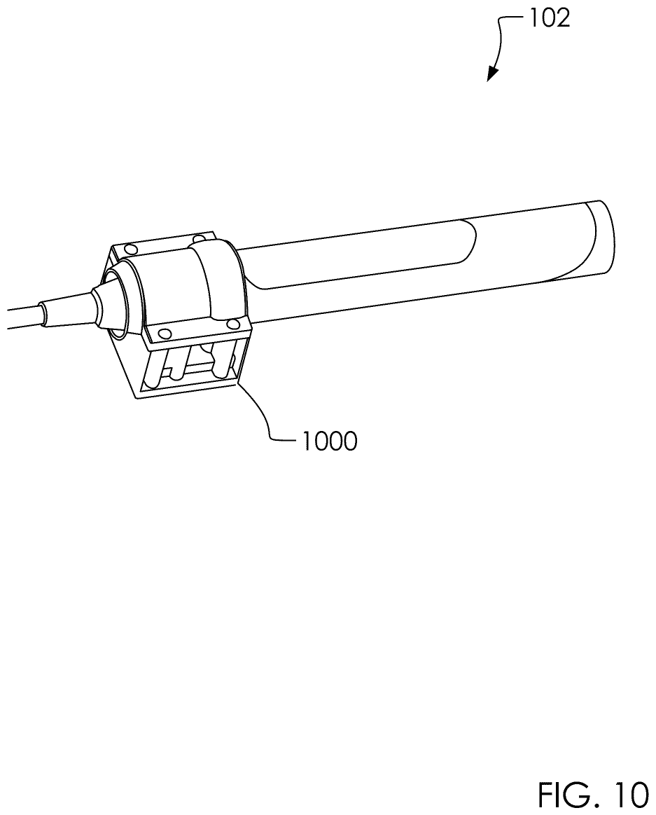

FIG. 10 illustrates a perspective overview of said handle assembly 102 featuring a magnet sleeve assembly 1000.

In one embodiment, said magnet sleeve assembly 1000 can be configured as an external attachment that slides onto or securely fits around said handle assembly 102. Said magnet sleeve assembly 1000 can house one or more magnets 600, enabling said handle assembly 102 to attach to metallic surfaces such as fences, equipment racks, or workstations.

Said magnet sleeve assembly 1000 can be constructed to ensures a secure fit and minimal interference with the ergonomics and operational functionality of said handle assembly 102.

This modular approach allows users to retrofit magnetic features onto said cattle prod 100 without altering its original structure or protective coating. The ability to add or remove said magnet sleeve assembly 1000 provides flexibility, enabling customization based on user preferences or specific operational needs.

### PARTS LIST

cattle prod 100,
handle assembly 102,
shaft assembly 104,
handle portion 106,
first coupling assembly 108,
activation button 110,
first handle end 112,
second handle end 114,
grip portion 116,
first shaft end 118,
second shaft end 120,
second coupling assembly 122,
shaft portion 124,
prod assembly 126,
charging port cover 200,
closed configuration 202,
open configuration 204,
charging port 206,
charging cable 208,
power meter 300,
battery 302,
one or more discharge control components 400,
control system 402,
wireless charging receiver 500,
wireless charging base 502,
one or more magnets 600,
core housing body 800,
button aperture 802,
upper coupling interface 804,
threaded connector assembly 806,
threaded coupling assembly 808,
base connector 810,
threaded attachment collar 812,
sealing flange 814,
protective coating 816,
internal cavity 820,
connector channel 822, and
magnet sleeve assembly 1000.

### Preferred Embodiment Based on the Original Claims

Said cattle prod 100 comprising an electrical prod for the livestock industry, said cattle prod 100 can comprise said cattle prod 100 comprises handle assembly 102 and shaft assembly 104. Said handle assembly 102 comprises the handle portion 106 having the first handle end 112 and the second handle end 114, the first coupling assembly 108 at said first handle end 112, the activation button 110, and the battery 302 for operating said cattle prod 100. Said shaft assembly 104 comprises the shaft portion 124 having the first shaft end 118 and the second shaft end 120, the second coupling assembly 122 at said first shaft end 118, the prod assembly 126 at said second shaft end 120. Said second coupling assembly 122 and said first coupling assembly 108 can be configured to selectively attach to one another. Said handle assembly 102 comprises the core housing body 800 having the button aperture 802, the upper coupling interface 804, and the internal cavity 820. Said handle assembly 102 can be configured to enclose said internal cavity 820 of said handle assembly 102. Said internal cavity 820 can be configured to hold one or more electrical components of said cattle prod 100. Said internal cavity 820 can be further configured to be sealed from environmental contamination and moisture. Said upper coupling interface 804 can be configured for matting with said shaft assembly 104. Said button aperture 802 can be configured for mating with said activation button 110, said cattle prod 100 can be configured to couple said internal cavity 820 with said shaft assembly 104 using said first coupling assembly 108 and said second coupling assembly 122, said handle assembly 102 comprises said core housing body 800 and the protective coating 816. Said handle assembly 102 protects said internal cavity 820 by sealing said activation button 110 under a portion of said protective coating 816 securely channeling said internal cavity 820 into a portion of said shaft assembly 104 through said first coupling assembly 108 and said second coupling assembly 122. Said activation button 110 can be configured to be useful through a portion of said protective coating 816 which can be flexible allowing movement of said activation button 110. Said handle assembly 102 comprises said core housing body 800 comprising an injection molded polymer, and said protective coating 816 comprising a secondary over molding to encapsulate said core housing body 800. Said protective coating 816 comprises the grip portion 116 of said handle assembly 102. Said protective coating 816 extends to the edges of said button aperture 802, further safeguarding said activation button 110 from environmental exposure.

Said weather-resistant material comprises rubber.

Said cattle prod 100 further comprises magnet sleeve assembly 1000. Said magnet sleeve assembly 1000 comprises an external attachment that slides onto or securely fits around said handle assembly 102. Said magnet sleeve assembly 1000 houses one or more magnets 600, enabling said handle assembly 102 to attach to metallic surfaces.

SAID cattle prod 100 comprising an electrical prod for the livestock industry, said cattle prod 100 can comprise said cattle prod 100 comprises handle assembly 102 and shaft assembly 104. Said handle assembly 102 comprises the handle portion 106 having the first handle end 112 and the second handle end 114, the first coupling assembly 108 at said first handle end 112, the activation button 110, and the battery 302 for operating said cattle prod 100. Said shaft assembly 104 comprises the shaft portion 124 having the first shaft end 118 and the second shaft end 120, the second coupling assembly 122 at said first shaft end 118, the prod assembly 126 at said second shaft end 120. Said second coupling assembly 122 and said first coupling assembly 108 can be configured to selectively attach to one another. Said handle assembly 102 comprises the core housing body 800 having the button aperture 802, the upper coupling interface 804, and the internal cavity 820. Said handle assembly 102 can be configured to enclose said internal cavity 820 of said handle assembly 102. Said internal cavity 820 can be configured to hold one or more electrical components of said cattle prod 100. Said internal cavity 820 can be further configured to be sealed from environmental contamination and moisture. Said upper coupling interface 804 can be configured for matting with said shaft assembly 104. Said button aperture 802 can be configured for mating with said activation button 110, said cattle prod 100 can be configured to couple said internal cavity 820 with said shaft assembly 104 using said first coupling assembly 108 and said second coupling assembly 122, said handle assembly 102 comprises said core housing body 800 and the protective coating 816. Said handle assembly 102 protects said internal cavity 820 by sealing said activation button 110 under a portion of said protective coating 816 securely channeling said internal cavity 820 into a portion of said shaft assembly 104 through said first coupling assembly 108 and said second coupling assembly 122. Said activation button 110 can be configured to be useful through a portion of said protective coating 816 which can be flexible allowing movement of said activation button 110.

Said second coupling assembly 122 and said first coupling assembly 108 comprise a threading configured to mate with one another.

Said cattle prod 100 further comprises the wireless charging receiver 500 and the wireless charging base 502. Said wireless charging receiver 500 can be encased within said cattle prod 100. Said wireless charging receiver 500 and said wireless charging base 502 selectively mate to wirelessly charge said battery 302.

Said cattle prod 100 comprises a wireless charging feature utilizing said wireless charging receiver 500 and said wireless charging base 502. Said wireless charging receiver 500 and said wireless charging base 502 operate using inductive charging technology.

Said cattle prod 100 further comprises one or more magnets 600 within said handle assembly 102. Said one or more magnets 600 can be arranged to allow said handle assembly 102 to selectively attach to metal surfaces.

Said one or more magnets 600 can be encased within a portion of said handle assembly 102.

Said threaded connector assembly 806 comprises the base connector 810, the threaded attachment collar 812, and the sealing flange 814. Said threaded connector assembly 806 can be securely attached to said core housing body 800. Said threaded connector assembly 806 comprises the connector channel 822 which creates a channel between said internal cavity 820 and said shaft assembly 104.

Said threaded connector assembly 806 further comprises the threaded coupling assembly 808 configured to secure said handle assembly 102 to said shaft assembly 104.

Said base connector 810 slides into said upper coupling interface 804 of said core housing body 800, while said sealing flange 814 rests on the upper edge of said core housing body 800 around said upper coupling interface 804.

Said threaded connector assembly 806 can be securely attached to said core housing body 800.

Said handle assembly 102 comprises said core housing body 800 comprising an injection molded polymer, and said protective coating 816 comprising a secondary over molding to encapsulate said core housing body 800. Said protective coating 816 comprises the grip portion 116 of said handle assembly 102. Said protective coating 816 extends to the edges of said button aperture 802, further safeguarding said activation button 110 from environmental exposure.

Said weather-resistant material comprises rubber.

Said cattle prod 100 further comprises magnet sleeve assembly 1000. Said magnet sleeve assembly 1000 comprises an external attachment that slides onto or securely fits around said handle assembly 102. Said magnet sleeve assembly 1000 houses said one or more magnets 600, enabling said handle assembly 102 to attach to metallic surfaces.

SAID cattle prod 100 comprising an electrical prod for the livestock industry, said cattle prod 100 can comprise said cattle prod 100 comprises handle assembly 102 and shaft assembly 104. Said handle assembly 102 comprises the handle portion 106 having the first handle end 112 and the second handle end 114, the first coupling assembly 108 at said first handle end 112, the activation button 110, and the battery 302 for operating said cattle prod 100. Said shaft assembly 104 comprises the shaft portion 124 having the first shaft end 118 and the second shaft end 120, the second coupling assembly 122 at said first shaft end 118, the prod assembly 126 at said second shaft end 120. Said second coupling assembly 122 and said first coupling assembly 108 can be configured to selectively attach to one another. Said handle assembly 102 comprises the core housing body 800 having the button aperture 802, the upper coupling interface 804, and the internal cavity 820. Said handle assembly 102 can be configured to enclose said internal cavity 820 of said handle assembly 102. Said internal cavity 820 can be configured to hold one or more electrical components of said cattle prod 100. Said internal cavity 820 can be further configured to be sealed from environmental contamination and moisture. Said upper coupling interface 804 can be configured for matting with said shaft assembly 104. Said button aperture 802 can be configured for mating with said activation button 110, said cattle prod 100 can be configured to couple said internal cavity 820 with said shaft assembly 104 using said first coupling assembly 108 and said second coupling assembly 122, said handle assembly 102 comprises said core housing body 800 and the protective coating 816. Said handle assembly 102 protects said internal cavity 820 by sealing said activation button 110 under a portion of said protective coating 816 securely channeling said internal cavity 820 into a portion of said shaft assembly 104 through said first coupling assembly 108 and said second coupling assembly 122. Said activation button 110 can be configured to be useful through a portion of said protective coating 816 which can be flexible allowing movement of said activation button 110. Said cattle prod 100 further comprises the wireless charging receiver 500 and the wireless charging base 502. Said wireless charging receiver 500 can be encased within said cattle prod 100. Said wireless charging receiver 500 and said wireless charging base 502 selectively mate to wirelessly charge said battery 302.

Said cattle prod 100 comprises a wireless charging feature utilizing said wireless charging receiver 500 and said wireless charging base 502. Said wireless charging receiver 500 and said wireless charging base 502 operate using inductive charging technology.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A cattle prod comprising an electrical prod for the livestock industry, said cattle prod comprising:
said cattle prod comprises handle assembly and shaft assembly;
said handle assembly comprises
a handle portion having a first handle end and a second handle end,
a first coupling assembly at said first handle end,
an activation button, and
a battery for operating said cattle prod;
said shaft assembly comprises
a shaft portion having a first shaft end and a second shaft end,
a second coupling assembly at said first shaft end,
a prod assembly at said second shaft end;
said second coupling assembly and said first coupling assembly are configured to selectively attach to one another;
said handle assembly comprises a core housing body having
a button aperture,
a upper coupling interface, and
an internal cavity;
said handle assembly is configured to enclose said internal cavity of said handle assembly;
said internal cavity is configured to hold one or more electrical components of said cattle prod;
said internal cavity is further configured to be sealed from environmental contamination and moisture;
said upper coupling interface is configured for matting with said shaft assembly;
said button aperture is configured for mating with said activation button,
said cattle prod is configured to couple said internal cavity with said shaft assembly using said first coupling assembly and said second coupling assembly,
said handle assembly comprises
said core housing body and
a protective coating;
said handle assembly protects said internal cavity by
sealing said activation button under a portion of said protective coating
securely channeling said internal cavity into a portion of said shaft assembly through said first coupling assembly and said second coupling assembly;
said activation button is configured to be useful through a portion of said protective coating which is flexible allowing movement of said activation button;
said handle assembly comprises
said core housing body comprising an injection molded polymer, and
said protective coating comprising a secondary over molding to encapsulate said core housing body;
said protective coating comprises a grip portion of said handle assembly; and
said protective coating extends to the edges of said button aperture, further safeguarding said activation button from environmental exposure.

2. Said cattle prod of claim 1, wherein:
said weather-resistant material comprises rubber.

3. Said cattle prod of claim 1, wherein:
said cattle prod further comprises magnet sleeve assembly;
said magnet sleeve assembly comprises an external attachment that slides onto or securely fits around said handle assembly; and
said magnet sleeve assembly houses one or more magnets, enabling said handle assembly to attach to metallic surfaces.

4. A cattle prod comprising an electrical prod for the livestock industry, said cattle prod comprising:
said cattle prod comprises handle assembly and shaft assembly;
said handle assembly comprises
a handle portion having a first handle end and a second handle end,
a first coupling assembly at said first handle end,
an activation button, and
a battery for operating said cattle prod;
said shaft assembly comprises
a shaft portion having a first shaft end and a second shaft end,
a second coupling assembly at said first shaft end,
a prod assembly at said second shaft end;
said second coupling assembly and said first coupling assembly are configured to selectively attach to one another;
said handle assembly comprises a core housing body having
a button aperture,
a upper coupling interface, and
an internal cavity;
said handle assembly is configured to enclose said internal cavity of said handle assembly;
said internal cavity is configured to hold one or more electrical components of said cattle prod;
said internal cavity is further configured to be sealed from environmental contamination and moisture;
said upper coupling interface is configured for matting with said shaft assembly;
said button aperture is configured for mating with said activation button,
said cattle prod is configured to couple said internal cavity with said shaft assembly using said first coupling assembly and said second coupling assembly,
said handle assembly comprises
said core housing body and
a protective coating;
said handle assembly protects said internal cavity by
sealing said activation button under a portion of said protective coating
securely channeling said internal cavity into a portion of said shaft assembly through said first coupling assembly and said second coupling assembly; and
said activation button is configured to be useful through a portion of said protective coating which is flexible allowing movement of said activation button.

5. Said cattle prod of claim 4, wherein:
said second coupling assembly and said first coupling assembly comprise a threading configured to mate with one another.

6. Said cattle prod of claim 4, wherein:
said cattle prod further comprises a wireless charging receiver and a wireless charging base;
said wireless charging receiver is encased within said cattle prod; and
said wireless charging receiver and said wireless charging base selectively mate to wirelessly charge said battery.

7. Said cattle prod of claim 6, wherein:
said cattle prod comprises a wireless charging feature utilizing said wireless charging receiver and said wireless charging base; and
said wireless charging receiver and said wireless charging base operate using inductive charging technology.

8. Said cattle prod of claim 4, wherein:
said cattle prod further comprises one or more magnets within said handle assembly; and
said one or more magnets are arranged to allow said handle assembly to selectively attach to metal surfaces.

9. Said cattle prod of claim 8, wherein:
said one or more magnets are encased within a portion of said handle assembly.

10. Said cattle prod of claim 4, wherein:
a threaded connector assembly comprises a base connector, a threaded attachment collar, and a sealing flange;
said threaded connector assembly is securely attached to said core housing body; and
said threaded connector assembly comprises a connector channel which creates a channel between said internal cavity and said shaft assembly.

11. Said cattle prod of claim 10, wherein:
said threaded connector assembly further comprises a threaded coupling assembly configured to secure said handle assembly to said shaft assembly.

12. Said cattle prod of claim 10, wherein:
said base connector slides into said upper coupling interface of said core housing body, while said sealing flange rests on the upper edge of said core housing body around said upper coupling interface.

13. Said cattle prod of claim 10, wherein:
said threaded connector assembly is securely attached to said core housing body.

14. Said cattle prod of claim 4, wherein:
said handle assembly comprises
said core housing body comprising an injection molded polymer, and
said protective coating comprising a secondary over molding to encapsulate said core housing body;
said protective coating comprises a grip portion of said handle assembly; and
said protective coating extends to the edges of said button aperture, further safeguarding said activation button from environmental exposure.

15. Said cattle prod of claim 14, wherein:
said weather-resistant material comprises rubber.

16. Said cattle prod of claim 4, wherein:
said cattle prod further comprises magnet sleeve assembly;
said magnet sleeve assembly comprises an external attachment that slides onto or securely fits around said handle assembly; and
said magnet sleeve assembly houses said one or more magnets, enabling said handle assembly to attach to metallic surfaces.

17. A cattle prod comprising an electrical prod for the livestock industry, said cattle prod comprising:
said cattle prod comprises handle assembly and shaft assembly;
said handle assembly comprises
a handle portion having a first handle end and a second handle end,
a first coupling assembly at said first handle end,
an activation button, and
a battery for operating said cattle prod;
said shaft assembly comprises
a shaft portion having a first shaft end and a second shaft end,
a second coupling assembly at said first shaft end,
a prod assembly at said second shaft end;
said second coupling assembly and said first coupling assembly are configured to selectively attach to one another;
said handle assembly comprises a core housing body having
a button aperture,
a upper coupling interface, and
an internal cavity;
said handle assembly is configured to enclose said internal cavity of said handle assembly;
said internal cavity is configured to hold one or more electrical components of said cattle prod;
said internal cavity is further configured to be sealed from environmental contamination and moisture;
said upper coupling interface is configured for matting with said shaft assembly;
said button aperture is configured for mating with said activation button,
said cattle prod is configured to couple said internal cavity with said shaft assembly using said first coupling assembly and said second coupling assembly,
said handle assembly comprises
said core housing body and
a protective coating;
said handle assembly protects said internal cavity by
sealing said activation button under a portion of said protective coating
securely channeling said internal cavity into a portion of said shaft assembly through said first coupling assembly and said second coupling assembly;
said activation button is configured to be useful through a portion of said protective coating which is flexible allowing movement of said activation button;
said cattle prod further comprises a wireless charging receiver and a wireless charging base;
said wireless charging receiver is encased within said cattle prod; and
said wireless charging receiver and said wireless charging base selectively mate to wirelessly charge said battery.

18. Said cattle prod of claim 17, wherein:
said cattle prod comprises a wireless charging feature utilizing said wireless charging receiver and said wireless charging base; and
said wireless charging receiver and said wireless charging base operate using inductive charging technology.
